(19) United States
(12) Patent Application Publication
(10) Pub. No.: US 2018/0107496 A1
(43) Pub. Date: Apr. 19, 2018

(54) METHOD OF EXPANDING FUNCTION OF ANDROID STANDARD MULTIMEDIA PLAYER AND MULTIMEDIA PLAYING SYSTEM

(71) Applicants: Xutong HU, Anhui (CN); MediaTek Singapore Pte. Ltd., Singapore (SG)

(72) Inventor: Xu-Tong HU, Hefei City, Anhui Province (CN)

(21) Appl. No.: 15/562,531

(22) PCT Filed: Mar. 30, 2015
(86) PCT No.: PCT/CN2015/075402

§ 371 Date: Sep. 28, 2017

(51) Int. Cl. G06F 9/445

(52) U.S. Cl. CPC G06F 9/44505; G06F 9/44521

(57) ABSTRACT

A method of expanding the function of an Android standard multimedia player is provided in the invention. The method includes the steps of: registering on an Android system an expanded multimedia player that is different from the Android standard multimedia player; setting on the Android operating system a derived class inheriting a JAVA interface layer of the Android player; instructing the expanded multimedia player to perform multimedia playing with respect to a playing target via the derived class. A multimedia playing system is further provided in the invention. The present invention can improve media capability of the multimedia player through the above method, thereby effectively improving user experience.

### FIELD OF THE INVENTION

The present invention relates to Android operating systems, and in particular, to a method of expanding the function of an Android standard multimedia player and a multimedia playing system.

### DESCRIPTION OF THE RELATED ART

Since the advent of the Android operating system, the Android OS has been widely used in smart electronic devices, particularly smartphones. In a smart electronic device equipped with the Android OS, an Android standard multimedia player is also built in to the smart electronic device, and multimedia files can be played via the Android standard multimedia player. The Android standard multimedia player receives multimedia files via the Android player JAVA (i.e. a computer programming language) interface, and provides an interface to the JAVA language via a JAVA local interface multimedia player library (libmedia). The media player library provides a player-type interface to the JAVA local interface in the upper level. The multimedia player service is a media server that implements a server function using the types of multimedia player library, and displays multimedia files using the playing core in the lower level.

However, significant changes to the Android code are not allowed by the Android open-source project (AOSP), and thus the media capability of the Android standard multimedia player is relatively weak. In the network age, having multiple types of data formats, the standard multimedia player is only capable of playing multimedia files that are in the formats supported by the Android standard multimedia player, and cannot play multimedia files of other types, resulting in poor user experience.

### BRIEF SUMMARY OF THE INVENTION

A function expansion method of the Android standard multimedia player and a multimedia playing system are provided in the invention to solve the technical problem of the weak media capability of the standard multimedia player.

To solve the aforementioned technical problem, a technical solution is used in the invention to provide a function expansion method of an Android standard multimedia player. The method includes the following steps: registering an expanded multimedia player that is different from the Android standard multimedia player on an Android operating system; setting a derived class inheriting a JAVA interface layer of the Android player on the Android operating system; instructing the expanded multimedia player to perform multimedia playing with respect to a playing target via the derived class.

To solve the aforementioned technical problem, another technical solution is used in the invention to provide a multimedia playing system, wherein the multimedia playing system comprises a playing server and an expanded multimedia player, and the playing server comprises a registering unit and a derived-class generating unit, wherein the registering unit is configured to register the expanded multimedia player that is different from the Android standard multimedia player on an Android operating system; the derived-class generating unit is configured to set a derived class inheriting a JAVA interface layer of the Android player, wherein the derived class instructs the expanded multimedia player to perform multimedia playing with respect to a playing target.

Distinguishing from existing techniques, the advantage of the present invention is that the method for expanding the function of the Android standard multimedia player may perform the following steps: registering an expanded multimedia player that is different from the Android standard multimedia player on an Android operating system; setting a derived class inheriting a JAVA interface layer of the Android player on the Android operating system; and instructing the expanded multimedia player to perform multimedia playing with respect to a playing target via the derived class. Thus, the expanded multimedia player is capable of playing multimedia files in the data formats unsupported by the Android standard multimedia player, thereby significantly increasing the media capability of the multimedia player, and improving user experience.

### BRIEF DESCRIPTION OF THE DRAWINGS

FIG. 1 is a flow chart of a function expansion method of an Android standard multimedia player in the invention;

FIG. 2 is a flow chart of step S102 in FIG. 1;

FIG. 3 is a flow chart of step S103 in FIG. 1;

FIG. 4 is a flow chart of playing a multimedia file by a multimedia player in the invention;

FIG. 5 is a first schematic diagram of a multimedia playing system in the invention.

FIG. 6 is a second schematic diagram of a multimedia playing system in the invention;

FIG. 7 is a schematic diagram of the derived-class generating unit in FIG. 6;

FIG. 8 is a schematic diagram of the expanded multimedia player in FIG. 5;

FIG. 9 is a schematic diagram of the Android standard multimedia player in FIG. 5.

### DETAILED DESCRIPTION OF THE INVENTION

The present invention can be more fully understood by reading the subsequent detailed description and the accompanying drawings.

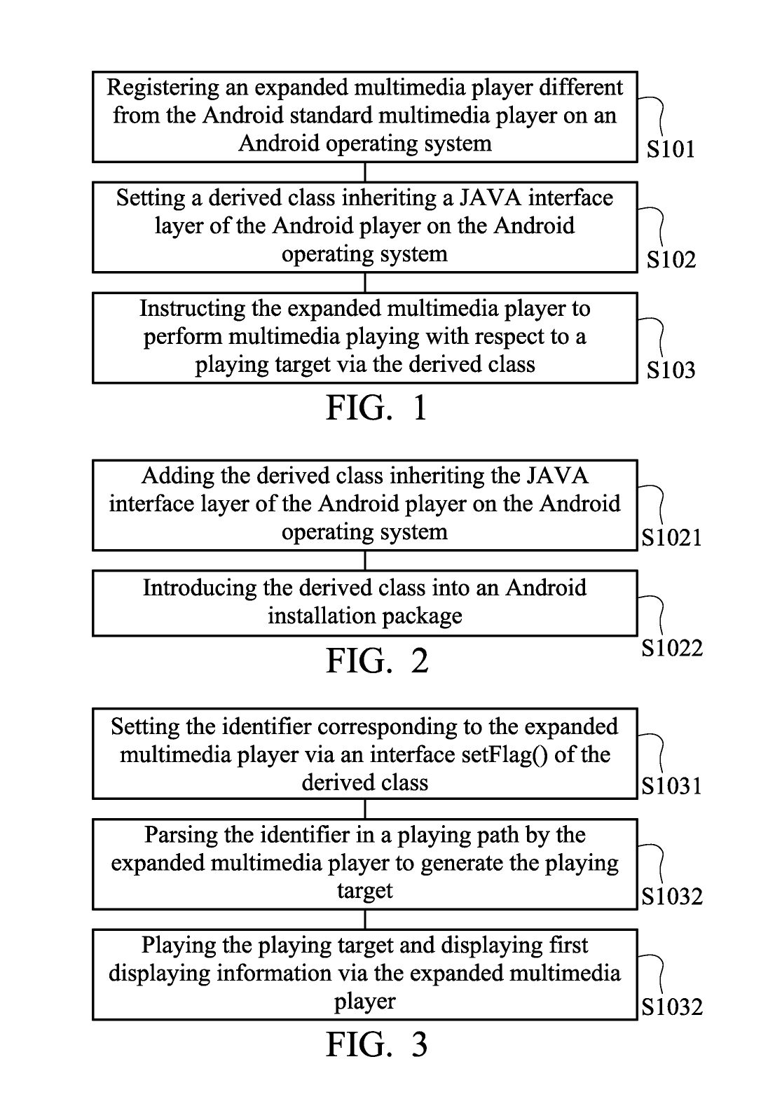

As shown in FIG. 1, FIG. 1 is a flow chart of a function expansion method of an Android standard multimedia player in the invention. The method includes the following steps:

Step S101: Registering an expanded media player that is different from the Android standard multimedia player on the Android operating system.

In the embodiment, the expanded multimedia player is configured to play multimedia files in data formats supported by a first data format set, and the Android standard multimedia player is configured to play multimedia files in data formats supported by a second data format set, wherein the data formats in the first and second data format sets are different. The first data format set includes but not limited to avi (Audio Video Interleaved), wmv (Windows Media Video, a steam media format developed by Microsoft), asf (Advanced Streaming Format), mov (an audio/video file format developed by Apple Inc.), mpg (an audio/video file format), mpeg (Moving Picture Experts Group), rm (a streaming media file format), fly (Flash Video), and ape (i.e. a lossless digital audio compression format). The second data format set includes but not limited to 3gp (a video codec format in 3G streaming media), mpg, mp3, mp4, is (high-definition movie packing format), flac (a lossless audio compression codec), ogg (a new audio compression format), mkv (a new multimedia packing format), webm (an open and free media file format), and way (an audio file format developed by Microsoft). In another embodiment, it should be understood that the first data format set may include the second data format set, or the first data format set includes a portion of data formats in the second data format set.

Preferably, multimedia files may be audio files, image files, or video files. It is appreciated that the multimedia files in the invention are not limited to audio files, image files, or video files, and may include other multimedia files.

Step S102: setting a derived class inheriting a JAVA interface layer of the Android player on the Android operating system. Specifically, as illustrated in FIG. 2, step S102 includes the following sub-steps:

Step S1021: adding the derived class inheriting the JAVA interface layer of the Android player on the Android operating system.

Step S1022: introducing the derived class into an Android installation package.

An interface setFlag( ) is added to the derived class in the invention, and an identifier can be set via the interface setFlag( ) The interface setDataSource( ) of the parent class (JAVA interface player of the Android player) is rewritten, so that the derived class will broadcast the identifier of the designated player to the player core in the lower level while using the interface setDataSource( ) in the parent class. In addition, the identifier is added into the beginning of the path of the multimedia file to be played.

Step S103: instructing the expanded multimedia player to perform multimedia playing with respect to a playing target via the derived class. Specifically, as illustrated in FIG. 3, step S103 includes the following sub-steps:

Step S1031: setting the identifier corresponding to the expanded multimedia player via the interface setFlag( ) of the derived class. There are default values for the identifier settings, and the default values include a first default value, a second default value, or a third default value. For example, the first default value is 6.

The identifier is used to identify the expanded multimedia player, so that the expanded multimedia player is different from the Android standard multimedia player. The identifier of the expanded multimedia player is added into the beginning of an address of the playing target (i.e. multimedia files) to form the playing path of the playing target. After obtaining the playing path of the playing target, the interface setDataSource( ) in the JAVA interface layer of the Android player is called to sequentially transmit the identifier of the designated player to the JAVA local interface, the multimedia player library, the playing server, the expanded multimedia player, and the Android standard multimedia player.

In the embodiment, the first data format set is defined in the Android operating system in advance, and the first data format set corresponds to the default values of the identifiers. That is, the Android operating system may automatically recognize the values in the first data format set corresponding to the identifier. If the data format of the playing target recognized by the Android operating system is one data format in the first data format set, the identifier of the expanded multimedia player is added to the beginning of the address of the playing target, thereby obtaining the playing path of the playing target.

Step S1032: parsing the identifier in the playing path by the expanded multimedia player to generate the playing target. It should be understood that both the expanded multimedia player and the Android standard multimedia player parse the identifier in the playing path.

Specifically, when the Android standard multimedia player and the expanded multimedia player receive the playing path of the playing target to be played, both the expanded multimedia player and the Android standard multimedia player parse the identifier in the playing path. When the parsing result indicates “match” after parsing the identifier in the playing path by the expanded multimedia player, the expanded multimedia player generates the playing target. In other words, the expanded multimedia player is selected to playing the playing target, and the expanded multimedia player is ready for playing. When the parsing result indicates “match” after parsing the identifier in the playing path by the Android standard multimedia player, the Android standard multimedia player generates the playing target. In other words, the Android standard multimedia player is selected to playing the playing target, and the Android standard multimedia player is ready for playing.

Step S1033: playing the playing target and displaying first displaying information via the expanded multimedia player, wherein the first displaying information includes but not limited to audio information, video information, or brightness information.

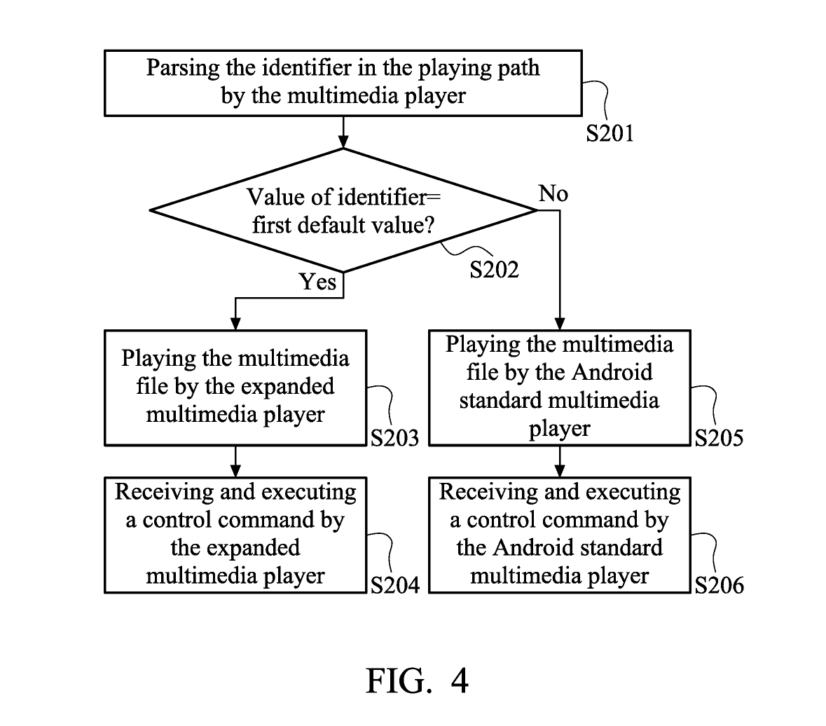

Specifically, as illustrated in FIG. 4, when the multimedia player plays the multimedia file, the method includes the following steps:

Step S201: parsing the identifier in the playing path by the multimedia player. It should be understood that both the Android standard multimedia player and the expanded multimedia player parse the identifier in the playing path.

Step S202: determining whether the value corresponding to the identifier is the first default value.

After determining the value corresponding to the identifier is the first default value, step S203 is performed. Step S203: playing the multimedia file by the expanded multimedia player. That is, the Android operating system generates the playing target, defines the first displaying information of the playing target, and utilizes the expanded multimedia player to play the playing target and display the first displaying information.

Step S204: receiving and executing a control command by the expanded multimedia player, wherein the control command includes at least one of a pause command, a play command, a stop command, a replay command, and a delete command.

A determination that the value corresponding to the identifier is not the first default value indicates that the data format of the multimedia file is a data format supported by the Android standard multimedia player, and step S205 is performed. Step S205: playing the multimedia file by the Android standard multimedia player. That is, the Android operating system generates the playing target, defines the second displaying information of the playing target, and utilizes the Android standard multimedia player to play the playing target and display the second displaying information, wherein the second displaying information includes but not limited to audio information, video information, or brightness information.

Step S206: receiving and executing a control command by the Android standard multimedia player, wherein the control command includes at least one of a pause command, a play command, a stop command, a replay command, and a delete command.

In the embodiment, a derived class inheriting the JAVA interface layer of the Android player is set, and the expanded multimedia player is designated by the derived class to perform multimedia playing, thereby improving the media capability of the multimedia player, and increasing the user experience.

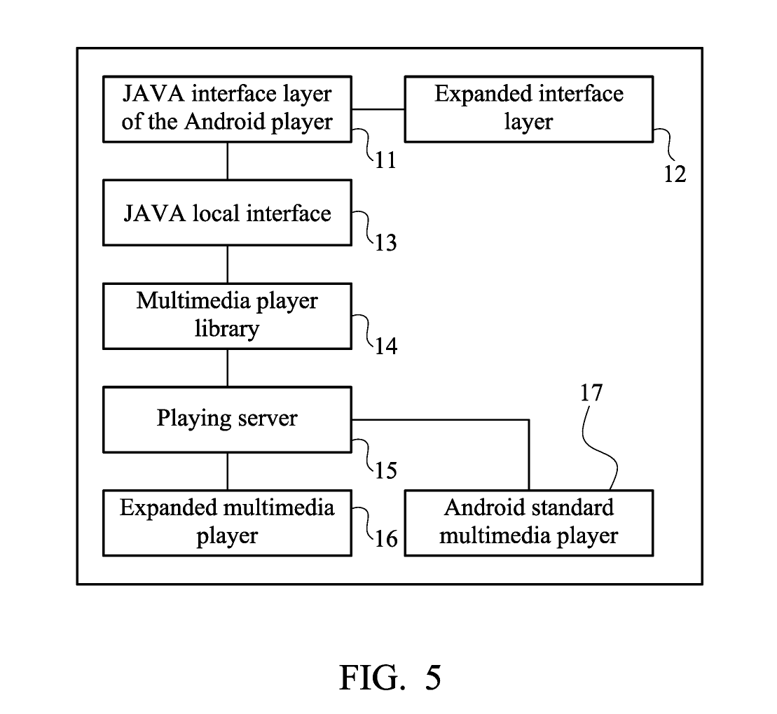

A multimedia playing system is further provided in the invention, as shown in FIG. 5. FIG. 5 is a first schematic diagram of the multimedia playing system of the invention. The multimedia playing system in FIG. 5 corresponds to the method in FIG. 1. The multimedia playing system includes a JAVA interface layer 11 of the Android player, an expanded interface layer 12, a JAVA local interface 13, a multimedia player library 14, a playing server 15, an expanded multimedia player 16, and an Android standard multimedia player 17.

The JAVA interface layer 11 of the Android player is configured to receive the Android multimedia applications.

The expanded interface layer 12 is configured to receive the multimedia application in a data format supported by the expanded multimedia player. It should be understood that the expanded interface layer 12 and the derived class in FIG. 1 are for describing the same object in different ways.

The JAVA local interface 13 is configured to call the multimedia player library to provide an interface to the JAVA.

The multimedia player library 14 is configured to provide a player-type interface to the JAVA local interface 13.

The playing server 15 is a media server which implements the server function by inheriting the multimedia player library, and performs multimedia playing by calling the expanded multimedia player 16 and the Android standard multimedia player 17 in the lower core level.

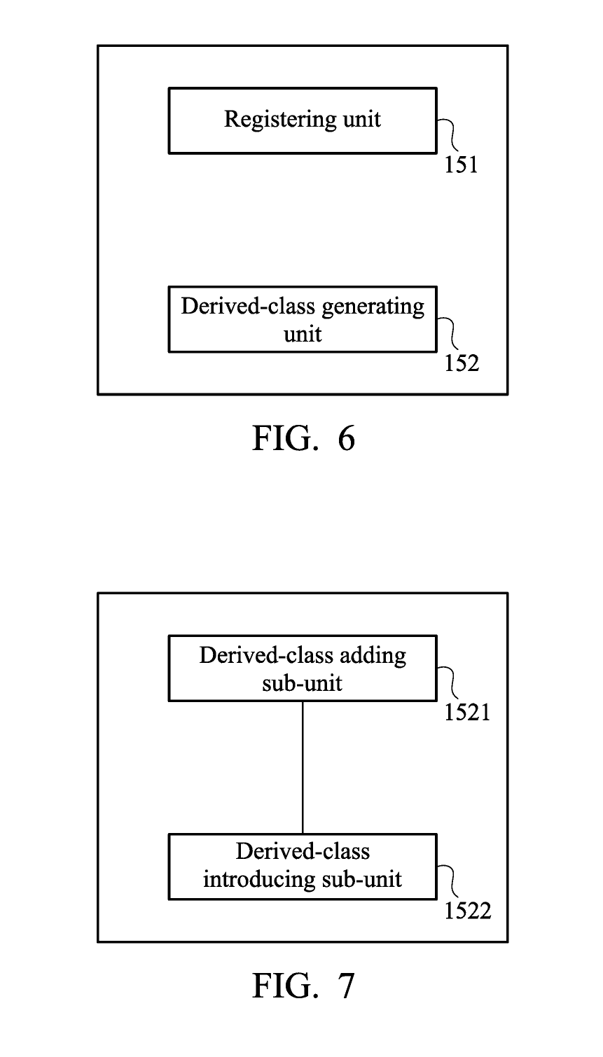

In another embodiment, as illustrated in FIG. 6, the multimedia playing system includes a registering unit 151 and a derived-class generating unit 152.

The registering unit 151 is configured to register the expanded multimedia player that is different from the Android standard multimedia player on the Android operating system.

The derived-class generating unit 152 is configured to set a derived class inheriting the JAVA interface layer of the Android player on the Android operating system. Specifically, as shown in FIG. 7, the derived-class generating unit 152 includes a derived-class adding sub-unit 1521 and a derived-class introducing sub-unit 1522. The derived-class adding sub-unit 1521 is configured to add a derived class inheriting the JAVA interface layer of the Android player on the Android operating system. The derived-class introducing sub-unit 1522 is configured to introduce the derived class into the Android package, so that the derived class instructs the expanded multimedia player 16 to perform multimedia playing with respect to the playing target.

The interface setFlag ( ) of the derived class in the aforementioned multimedia player sets the identifier corresponding to the expanded multimedia player. There are default values for the identifier settings, and the default values include a first default value, a second default value, or a third default value. For example, the first default value is 6. The identifier is used to identify the expanded multimedia player 16, so that the expanded multimedia player 16 is different from the Android standard multimedia player 17. The expanded interface layer 12 and the JAVA interface layer 11 of the Android player form a playing-path forming unit that is configured to add the identifier of the expanded multimedia player into the beginning of the address of the playing target (i.e. multimedia files) to form the playing path of the playing target. After obtaining the playing path of the playing target, the interface setDataSource( ) in the JAVA interface layer 11 of the Android player is called to sequentially transmit the identifier of the designated player to the JAVA local interface 13, the multimedia player library 14, the playing server 15, the expanded multimedia player 16, and the Android standard multimedia player 17.

In the embodiment, the first data format set is defined in the Android operating system in advance, and the first data format set corresponds to the default values of the identifiers. That is, the Android operating system may automatically recognize the values in the first data format set corresponding to the identifier. If the data format of the playing target recognized by the Android operating system is one data format in the first data format set, the identifier of the expanded multimedia player 16 is added to the beginning of the address of the playing target, thereby obtaining the playing path of the playing target.

The expanded multimedia player 16 is configured to parse the identifier in the playing path. It should be understood that the expanded multimedia player 16 and the Android standard multimedia player 17 are respectively used to parse the identifier in the playing path, so that the expanded multimedia player 16 or the Android standard multimedia player 17 generates the playing target.

Specifically, when the Android standard multimedia player 17 and the expanded multimedia player 16 receive the playing path of the playing target to be played, both the Android standard multimedia player 17 and the expanded multimedia player 16 parses the playing path. When the parsing result indicates “match” after parsing the identifier in the playing path by the expanded multimedia player 16, the expanded multimedia player 16 generates the playing target. In other words, the expanded multimedia player 16 is selected to playing the playing target, and the expanded multimedia player 16 is ready for playing. When the parsing result indicates “match” after parsing the identifier in the playing path by the Android standard multimedia player 17, the Android standard multimedia player 17 generates the playing target. In other words, the Android standard multimedia player 17 is selected to playing the playing target, and the Android standard multimedia player 17 is ready for playing.

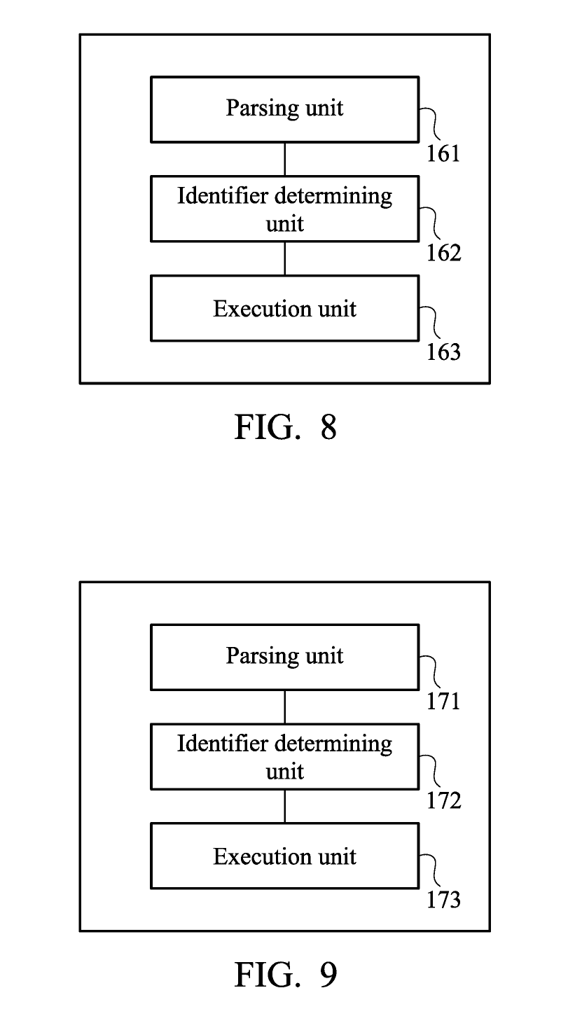

As shown in FIG. 8, the expanded multimedia player 16 includes a parsing unit 161, an identifier determining unit 162, and an execution unit 163. The parsing unit 161 is configured to parse the identifier in the playing path. The identifier determining unit 162 is configured to determine whether the value corresponding to the identifier is the first default value. The execution unit 163 is configured to call the expended multimedia player 16 to play the multimedia file when it is determined that the value corresponding to the identifier is the first default value. That is, the execution unit 163 generates the playing target corresponding to the expanded multimedia player 16 on the Android operating system, sets first display information of the playing target, and utilizes the expanded multimedia player 16 to play the playing target and display the first displaying information, wherein the first displaying information includes but not limited to audio information, video information, or brightness information. In addition, the execution unit 163 is further configured to receive and execute a control command, wherein the control command includes at least one of a pause command, a play command, a stop command, and a replay command.

As shown in FIG. 9, the Android standard multimedia player 17 includes a parsing unit 171, an identifier determining unit 172, and an execution unit 173. The parsing unit 171 is configured to parse the identifier in the playing path. The identifier determining unit 172 is configured to determine whether the value corresponding to the identifier is the first default value. The execution unit 173 is configured to call the Android standard multimedia player 17 to play the multimedia file when it is determined that the value corresponding to the identifier is the first default value. That is, the execution unit 173 generates the playing target corresponding to the Android standard multimedia player 17 on the Android operating system, sets second display information of the playing target, and utilizes the Android standard multimedia player 17 to play the playing target and display the second displaying information, wherein the second displaying information includes but not limited to audio information, video information, or brightness information. In addition, the execution unit 173 is further configured to receive and execute a control command, wherein the control command includes at least one of a pause command, a play command, a stop command, and a replay command.

The multimedia player in the embodiment may set a derived class inheriting the JAVA interface layer of the Android player on the Android operating system, and the derived class may instruct the expanded multimedia player to perform multimedia playing, thereby improving the media capability of the multimedia player, and increasing the user experience.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method of expanding function of an Android standard multimedia player, the method comprising:
registering an expanded multimedia player that is different from the Android standard multimedia player on an Android operating system;
setting a derived class inheriting a JAVA interface layer of the Android player on the Android operating system; and
instructing the expanded multimedia player to perform multimedia playing with respect to a playing target via the derived class.

2. The method as claimed in claim 1, wherein the expanded multimedia player is configured to play multimedia files in data formats supported by a first data format set, and the Android standard multimedia player is configured to play multimedia files in data formats supported by a second data format set, and the data formats in the second data format set are different from those in the first data format set.

3. The method as claimed in claim 1, wherein the step of setting the derived class inheriting the JAVA interface layer of the Android player on the Android operating system comprises:
adding the derived class inheriting the JAVA interface layer of the Android player on the Android operating system; and
introducing the derived class into an Android installation package.

4. The method as claimed in claim 3, wherein the step of instructing the expanded multimedia player to perform multimedia playing with respect to the playing target via the derived class comprises:
setting the identifier corresponding to the expanded multimedia player via an interface setFlag( ) of the derived class;
parsing the identifier in a playing path by the expanded multimedia player to generate the playing target; and
playing the playing target and displaying first displaying information via the expanded multimedia player.

5. The method as claimed in claim 4, wherein the method further comprises:
adding the identifier of the expanded multimedia player into the beginning of an address of the playing target to form the playing path of the playing target.

6. The method as claimed in claim 4, wherein the step of parsing the identifier in the playing path via the expanded multimedia player comprises:
determining whether a value corresponding to the identifier is a first default value; and
utilizing the expanded multimedia player to play the playing target after determining that the value corresponding to the identifier is the first default value.

7. The method as claimed in claim 1, wherein the method further comprises:
receiving and executing a control command, wherein the control command comprises at least one of a pause command, a play command, a stop command, and a replay command.

8. The method as claimed in claim 1, wherein the playing target is an audio file, an image file, or a video file.

9. A multimedia playing system, wherein the multimedia playing system comprises an Android standard multimedia player and an expanded multimedia player, and the multimedia playing system further comprises:
a registering unit, configured to register the expanded multimedia player that is different from the Android standard multimedia player on an Android operating system; and
a derived-class generating unit is configured to set a derived class inheriting a JAVA interface layer of the Android player, wherein the derived class instructs the expanded multimedia player to perform multimedia playing with respect to a playing target.

10. The multimedia playing system as claimed in claim 9, wherein the expanded multimedia player is configured to play multimedia files in data formats supported by a first data format set, and the Android standard multimedia player is configured to play multimedia files in data formats supported by a second data format set, and the data formats in the second data format set are different from those in the first data format set.

11. The multimedia playing system as claimed in claim 9, wherein the derived-class generating unit comprises:
a derived-class adding sub-unit, configured to add the derived class inheriting the JAVA interface layer of the Android player on the Android operating system; and
a derived-class introducing sub-unit, configured to introduce the derived class into an Android installation package.

12. The multimedia playing system as claimed in claim 11, wherein the derived class comprises an interface setFlag( ) to set an identifier of the expanded multimedia player;
the expanded multimedia player comprises an parsing unit, configured to parse the identifier in a playing path, so that the expanded multimedia player generates a playing target; and
the expanded multimedia player plays the playing target and displays first displaying information.

13. The multimedia playing system as claimed in claim 12, comprising:
a playing-path forming unit, configured to add the identifier to the beginning of an address of the playing target to form the playing path of the playing target.

14. The multimedia playing system as claimed in claim 12, wherein the expanded multimedia player further comprises:
an identifier determining unit, configured to determine whether a value corresponding to the identifier is a first default value;
an execution unit, configured to utilize the expanded multimedia player to play the playing target when it is determined that the value corresponding to the identifier is the first default value.

15. The multimedia playing system as claimed in claim 14, wherein the execution unit is further configured to receive and execute a control command, wherein the control command comprises at least one of a pause command, a play command, a stop command, and a replay command.

16. The multimedia playing system as claimed in claim 9, wherein the playing target is an audio file, an image file, or a video file.
